(19) United States
(12) Patent Application Publication
(10) Pub. No.: US 2014/0229101 A1
(43) Pub. Date: Aug. 14, 2014

(54) SYSTEM, COMPONENTS AND METHODOLOGIES FOR NAVIGATION ROUTE PLANNING

(71) Applicants: Erik GLASER, (US); Heiko MAIWAND, (US); Patrick BARTSCH, (US); William Brian LATHROP, (US); VOLKSWAGEN AG, Wolfsburg (DE); AUDI AG, Ingolstadt (DE)

(72) Inventors: Erik GLASER, Palo Alto, CA (US); Heiko MAIWAND, Foster City, CA (US); Patrick BARTSCH, Isenbuttel (DE); William Brian LATHROP, Palo Alto, CA (US)

(73) Assignees: AUDI AG, Ingolstadt (DE); VOLKSWAGEN AG, Wolfsburg (DE)

(21) Appl. No.: 13/762,668

(22) Filed: Feb. 8, 2013

(51) Int. Cl. G01C 21/34

(52) U.S. Cl. CPC G01C 21/34
USPC 701/487; 701/538; 701/533; 701/527; 701/537

(57) ABSTRACT

A navigation system, components and methodologies enables a process for including a specific route segment on a calculated route from a starting location to a destination. Accordingly, the navigation system, its components and the associated navigation route planning methodologies enable planning based on at least a user's personal preference for the inclusion of at least one specific route segment in a planned navigation route.

### BACKGROUND

The present disclosure relates to a system, components and methodologies for navigation route planning. In particular, the present disclosure is directed to a system, components and methodologies that enable navigation planning for a driver/passenger in a vehicle to form an in-vehicle navigation system.

### SUMMARY

According to the present disclosure, a navigation system simplifies the process for including a specific route segment on a calculated route from a starting location to a destination. Accordingly, the navigations system, its components and the associated navigation route planning methodologies enable planning based on at least a user's personal preference for the inclusion of at least one specific route segment in a planned navigation route.

In illustrative embodiments, the navigation system and at least some portion of its constituent components are included in an in-vehicle navigation system provided in combination with a vehicle to provide a transportation system.

In illustrative embodiments, the navigation system, its components and associated navigation route planning methodologies optimize a navigation route according to a user's personal preference for inclusion of at least one specific route segment as well as at least one of predicted time to travel the navigation route and distance along the navigation route.

Additional features of the present disclosure will become apparent to those skilled in the art upon consideration of illustrative embodiments exemplifying the best mode of carrying out the disclosure as presently perceived.

### BRIEF DESCRIPTION OF THE FIGURES

The detailed description particularly refers to the accompanying figures in which:

FIG. 1 is a block diagram view of an in-vehicle navigation system included in a transportation system that includes a passenger vehicle and the constituent components of the in-vehicle navigation system;

FIGS. 2-7 illustrate various examples of screen shots that may be displayed on a user interactive touch screen included in a user interface of a navigation system as part of planning of a completely open-ended scenic route (e.g., driving around a lake, etc.) provided in accordance with the presently disclosed embodiments;

FIG. 8 illustrates one example of a methodology for enabling planning of a completely open-ended scenic route corresponding to FIGS. 2-7;

FIGS. 9-13 illustrate various examples of screen shots that may be displayed on a user interactive touch screen included in a user interface of a navigation system as part of planning and making an adjustment to a previously traced navigation route provided in accordance with the presently disclosed embodiments;

FIG. 14 illustrates one example of a methodology for enabling planning and making an adjustment to a previously traced navigation route corresponding to FIGS. 9-13;

FIGS. 15-20 illustrate various examples of screen shots that may be displayed on a user interactive touch screen included in a user interface of a navigation system as part of enabling a user to adjust a previously traced route by cutting a segment out of a previously drawn navigation route to trigger re-drawing of the navigation route in accordance with the presently disclosed embodiments;

FIG. 21 illustrates one example of a methodology for enabling a user to adjust a previously traced route by cutting a segment out of a previously drawn navigation route to trigger re-drawing of the navigation route corresponding to FIGS. 15-20;

FIGS. 22-27 illustrate various examples of screen shots that may be displayed on a user interactive touch screen included in a user interface of a navigation system as part of a methodology enabling a user to input/trace a route segment for inclusion in a navigation route being formulated in accordance with the presently disclosed embodiments; and

FIG. 28 illustrates one example of a methodology for enabling a user to input/trace a route segment for inclusion in a navigation route being formulated corresponding to FIGS. 22-27.

### DETAILED DESCRIPTION

According to the present disclosure, a navigation system, whether it be part of an in-vehicle navigation system or otherwise, simplifies the process for including a specific route segment on a calculated route from a starting location to a destination. Accordingly, the navigation system, its components and the associated navigation route planning methodologies enable planning based on at least a user's personal preference for the inclusion of at least one specific route segment in a planned navigation route.

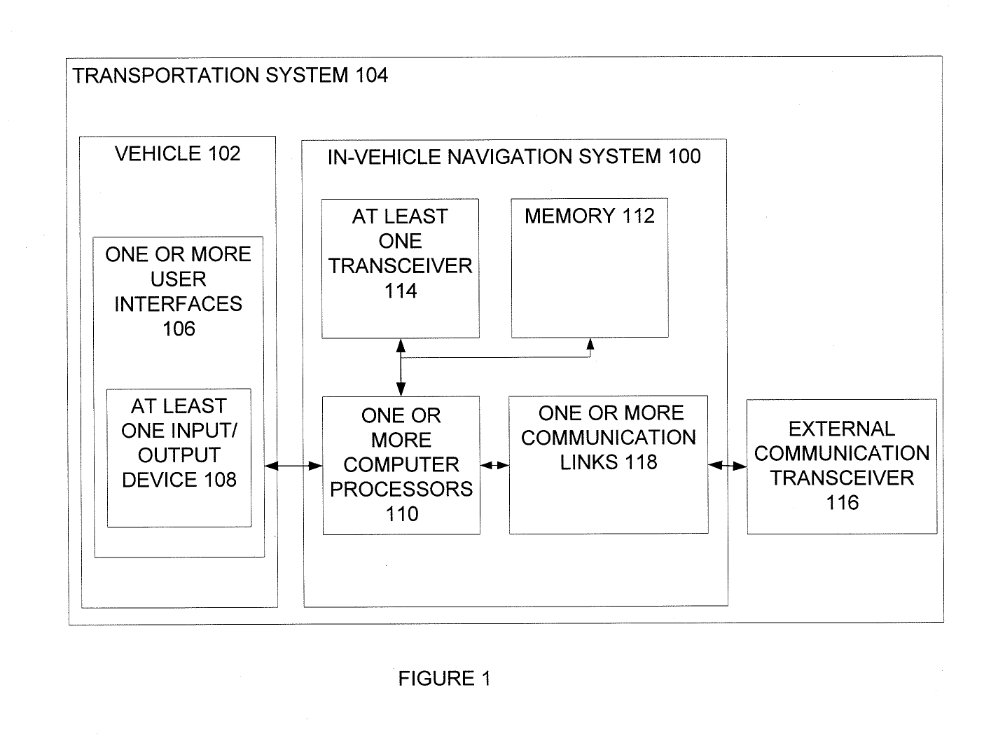

Accordingly, an in-vehicle navigation system offers users guidance from a starting location of a vehicle to one or more destinations of the vehicle. As illustrated in FIG. 1, the in-vehicle navigation system 100 may comprise a vehicle 102, e.g., an automotive vehicle or the like, or other vehicle effective to convey one or more persons and/or cargo from at least one location to at least one other location.

In illustrative embodiments, the in-vehicle navigation system 100 and at least some portion of its constituent components are included in an in-vehicle navigation system 100 are provided in combination with the vehicle to provide a transportation system. Thus, FIG. 1 provides a block diagram view of an in-vehicle navigation system 100 included in a transportation system 104 that includes a passenger vehicle 102 and the constituent components of the in-vehicle navigation system 100. The navigation system 100 may include one or more user interfaces 106 that are provided in an environment provided in the passenger cabin of the vehicle 102. The user interface(s) 106, e.g., an-in-vehicle display, may be configured to enable one or more users to interact with the user interface(s) 106 so as to receive information from at least one input/output device 108, e.g., a touch screen, and provide instructions to the in-vehicle navigation system 100 so as to facilitate navigation route planning via the system 100. It should be understood that the at least one user interface 106 and constituent input/output device 108 may optionally be implemented using a vehicle's dashboard control touch screen display. Accordingly, FIG. 1 illustrates those components as being part of the vehicle 102; however, the components may alternatively be considered to be part of the navigation system 100 itself.

The system 100 may further include one or more computer processors 110 that include software instructions stored in memory 112 (either included in the computer processor(s) 110) or accessible by the processor(s)) 110 and configured to enable navigation route planning via one or more routing algorithms, as explained herein.

The system 100 may also include at least one transceiver 114 that enables receipt of traffic information (e.g., traffic data indicating at least one of traffic accident event data for a geographic region and a level of traffic congestion in the geographic region) and other data of use in conventionally available navigation systems including Global Positioning System (GPS) data or other types of data that enable determination of the position of the system 100 in relationship to geographic locations, e.g., roads, landmarks, or other points as designated by GPS data or the like.

Alternatively, or in addition, the system 100 may include software that enables the use of an external communication transceiver 116, for example, that available in a mobile phone or similar cellular device that enables communication via at least one communication network, e.g., telecommunications networks, cellular networks, the Internet, etc. (public and/or private). Accordingly, the system 100 may include one or more communication links 118, e.g., Bluetooth®, WIFI, a Local Area Network (LAN), etc. that enable the system 100 to communicate with or via the external communication transceiver 116 and/or applications software and other applications running on a device (e.g., mobile phone, tablet computer, personal computational device, etc.) including that external communication link 116.

In presently disclosed embodiments, the actual coordinate data used for navigation may be in various formats. However, for terrestrial navigation coordinate data commonly includes longitude and latitude. The use of “waypoints” has become widespread for navigational use since the development of advanced navigational systems, such as the GPS and certain other types of radio navigation. Waypoints are sets of coordinates that identify a point's location in physical space.

Presently disclosed embodiments implemented in connection with a GPS transceiver and utilizing GPS data for formulating and guiding navigation routes, may use GPS data to create and use waypoints in navigation. As a result, in accordance with disclosed embodiments, one or more waypoints can be marked on a computer mapping algorithm and uploaded to a GPS transceiver included in the route navigation system, marked on the GPS receiver's own internal map, or entered manually via the user interface via touch screen selection by selecting a position on a displayed map or via entry of a pair of coordinates.

Likewise, in presently disclosed embodiments implemented in connection with a GPS transceiver and utilizing GPS data for formulating and guiding navigation routes, formulated “route” may be defined as a series of two or more waypoints. To follow such a route, the GPS navigation system navigates to the nearest waypoint, then to the next one in turn until the destination is reached.

Thus, presently disclosed embodiments may also be implemented to offer integrated cartographic databases (e.g., base maps), which enable a user to locate a point on a map and define it as a waypoint. Thus, in accordance with disclosed embodiments, the navigation route planning system can generate a suggested route between two waypoints based on comparison of user input data with one or more cartographic database.

Conventionally available navigation systems also use waypoints to define routing paths for navigation. Waypoints may be specified, for example, by longitude and latitude or Universal Transverse Mercator (UTM) coordinates plus the reference datum, and may be located using a radio navigation system such as a GPS receiver or a Very High Frequency (VHF) Omnidirectional Radio range (VOR). Thus, a waypoint can be a destination, a fix along a planned course used to make a journey, or simply a point of reference useful for navigation.

However, although conventionally available navigation systems may offer a user an opportunity to specify routes with less congestion, better scenery, fewer tolls and bridges, such navigation systems do not enable a user to influence a formulated navigation route beyond these basic set of parameters. For example, instructing such conventional navigation systems to include a specific segment on a route for its scenic value is very difficult if not impossible to do. More specifically, in conventionally available systems, a user may be forced to manually input a series of strategically placed waypoints along a proposed or previously formulated navigation route; however, this is both difficult and time consuming for the user.

One further drawback of some conventionally available navigation systems is that, even if these waypoints are manually input by a user a routing algorithm of the navigation system may still attempt to use an undesired highway or other unintended road segment(s).

However, the presently disclosed embodiments greatly simplify the process for including one or more specific, user-defined route segment(s) on a formulated route from a user's starting location to their destination. For example, in addition to optimizing a route according to time and/or distance, the presently disclosed embodiments facilitate the ability to perform route optimization according to personal preference of a user for the inclusion of specific route segments.

With this understanding of the functionality of the presently disclosed embodiments in mind, it should be understood that there are many route optimization strategies available in conventional and commercially available navigation systems today. For example, US Pat. Pub. 2010/0312466 provides a means to calculate alternative routes so that the user can then choose between faster or shorter routes. Likewise, US Pat. Pub. 2002/0120396 incorporates historical data for purposes of route planning, thereby allowing the user to avoid high crime areas during travel. Further, U.S. Pat. No. 7,865,298 improves the battery performance of electric cars by factoring in external temperature, traffic flow, and terrain when calculating routes. Moreover, if the user wants to influence the route beyond these types of parameters, he/she can instruct the system to simply calculate an alternative route, set waypoints, or perform manual manipulation on the route (e.g., Google maps' click and drag function).

However, each of these conventional systems and their associated methodologies, fail to enable route optimization according to personal preference of a user for the inclusion of at least one specific route segment. This is because there is no conventional way of easily and effectively including or adding a route segment to a currently calculated route using the conventionally available methods available in commercially available navigation system.

To the contrary, the presently disclosed embodiments enable a method for augmenting the calculation of a route between a user's current start location and a destination. Disclosed embodiments enable the user to specify, e.g., via touch input on a touch screen display the coordinates on a map through which to navigate.

Presently disclosed embodiments provide a system, components and methodologies that allow a user to adjust a route directly on the navigation map shown on the touch screen display. The touch screen shows a geographic map that displays the current position and a set destination. Methodologies enable the user to influence and optimize route planning by simply allowing the user to trace or draw directly on the touch screen to indicate a preferred route segment to include on the overall route. Importantly, the route segment can either be the “full route” if the user begins drawing at his/her current location and finishes drawing at his/her destination or just a partial segment of the user begins drawing anywhere on the map that is not his/her current location. This hand-drawn route is then compared and matched as closely as possible to the cartographic database data including designations of available roads, highways, etc. Thus, a customized route may be formulated to include this drawn segment.

In its simplest form, the coordinates could be a single point, whereas, the coordinate data could be more elaborate, e.g., including an entire navigation route. Further, disclosed embodiments may serve as a tool to include an additional route segment not included as part of the original results from a calculation of a route between a user's current location and destination.

This innovation can be extended to influence navigation route planning in various ways. For example, as referenced above, a user may be enabled to draw a preferred path from their current location all the way to the final destination on a displayed map. In addition, the disclosed embodiments may enable a user to draw only a segment of the route they are interested in and the remaining portion of the route may be interpolated by the system (from the current position to the beginning of the drawn segment, and from the end of the drawn segment to the set destination). Moreover, receipt of a user's touching on an area on the displayed map may be interpreted as a segment with no length, thus enabling the user to seta single waypoint. This is possible because the system may be configured to interpolate necessary route data from a current position to the selected waypoint and then from that waypoint to a previously formulated or identified destination. As a result, the navigation system, its components and associated methodologies enable various navigation capabilities that provide greater flexibility and the option to take into account a user's personal preferences regarding one or more specific locations to be included in a navigation route planned by the system, components and methodologies.

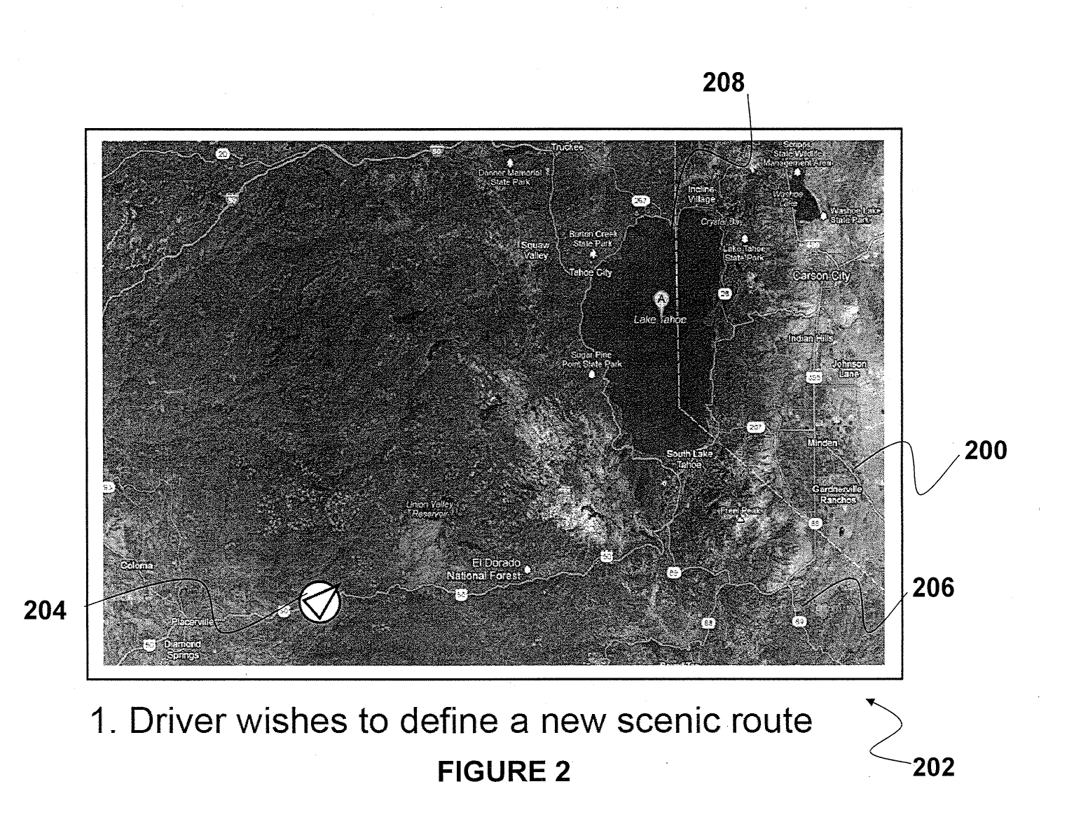

Accordingly, FIGS. 2-7 illustrate various examples of screen shots that may be displayed on a user interactive touch screen included in a user interface of a navigation system as part of planning of a completely open-ended scenic route (e.g., driving around a lake, etc.) provided in accordance with the presently disclosed embodiments.

As shown in FIG. 2, a geographic region map 200 may be displayed on a touch screen display 202 with an icon indicating a user's present location 204. Within the displayed geographic region, there may be displayed specific roads, highways and other routes 206 along with depictions of cities, towns, schools, businesses and geographic landmarks 208 including, e.g., valleys, mountains, state and country boundaries, etc. Accordingly, each of these routes and landmarks may be labeled with their corresponding names.

With this understanding in mind, FIG. 2 specifically illustrates, for example, a geographic region including Lake Tahoe located on the boundary between California and Nevada in the United States of America. As an illustrative example of the utility of the presently disclosed embodiments, presume that a user located in a motor vehicle driving east on US 50 (and indicated by the icon 204) is interested in formulating a navigation route that includes a scenic drive around Lake Tahoe.

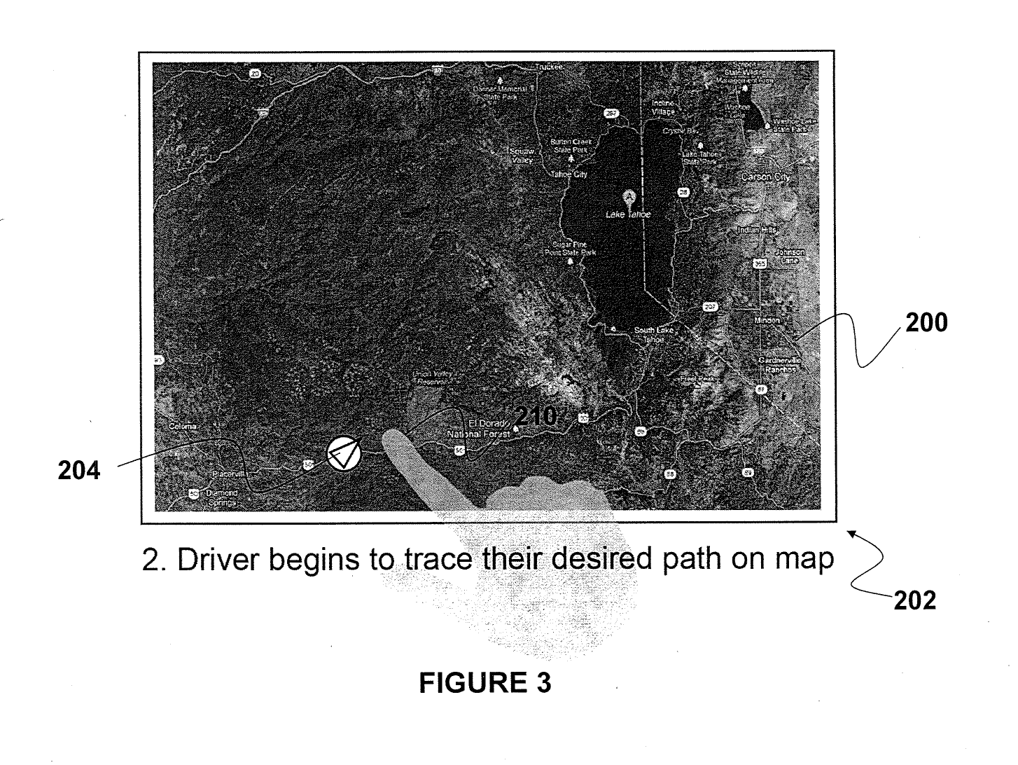

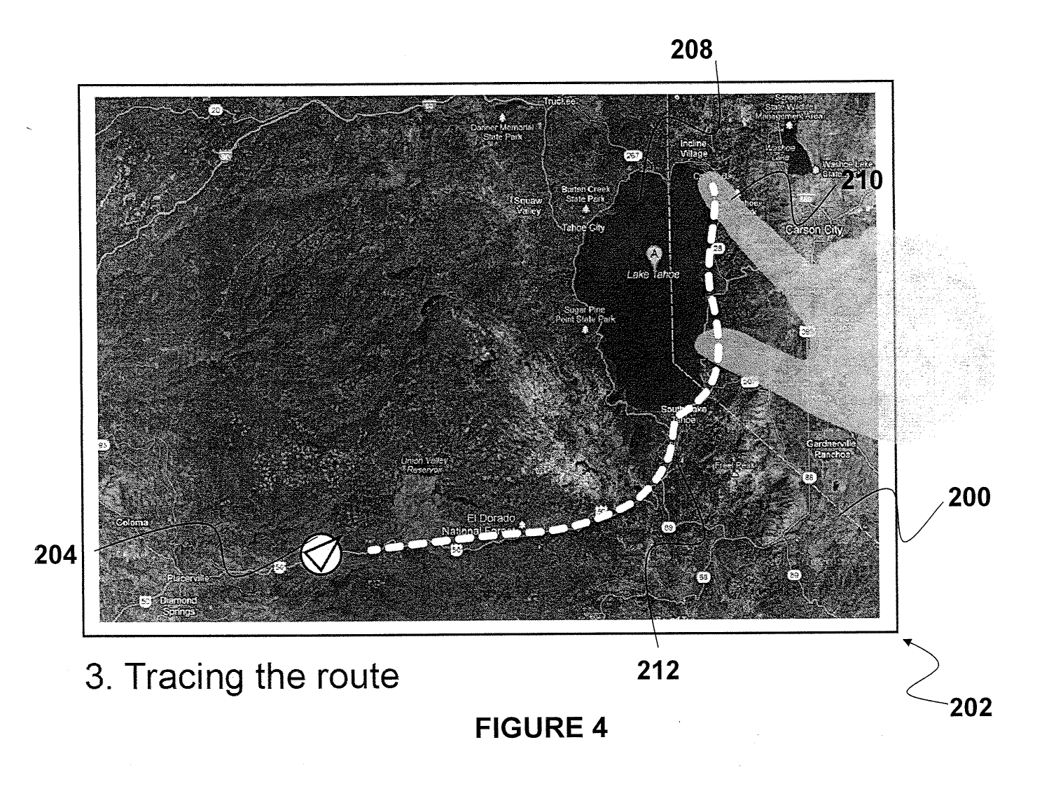

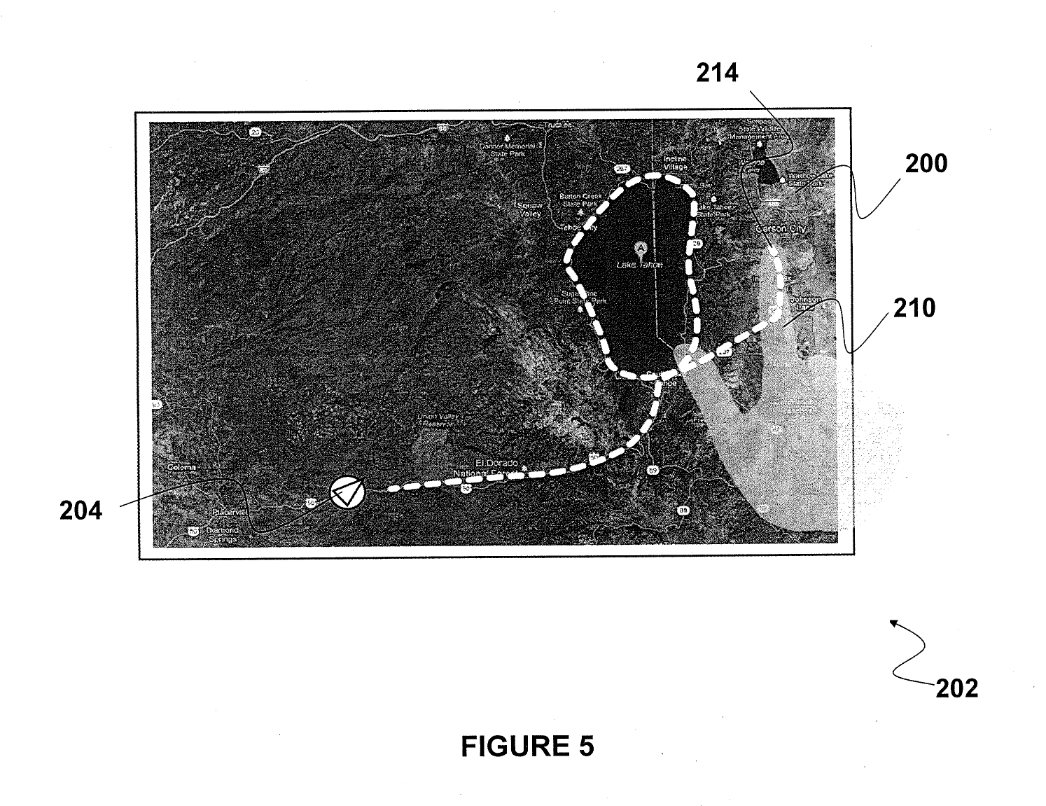

Accordingly, as illustrated in FIG. 3, the user (which may be, for example, a driver or passenger within a motor vehicle), begins to trace a desired path on the displayed map 200 displayed on the touch screen 202 using their finger 210 (noting that the user could use another digit or a stylus depending on the type of touch screen and personal preference of the user). Accordingly, the user could draw or trace a route segment 212 from the current position of the icon 204 (indicating the current position of the user) to and along the shore of Lake Tahoe 208, as shown in FIG. 4. Further, the user would also be enabled to circumvent Lake Tahoe by extending the drawn/traced route segment completely around the lake as shown in FIG. 5. The user could further designate a destination for the proposed navigation route, e.g., Carson City, Nev., by extending the drawn/traced route segment to that city. By recognizing that the user has then ended his drawing/tracing at Carson City, the navigation system recognizes that Carson City is the final destination 214 for the proposed route segment 212, here, the total navigation route.

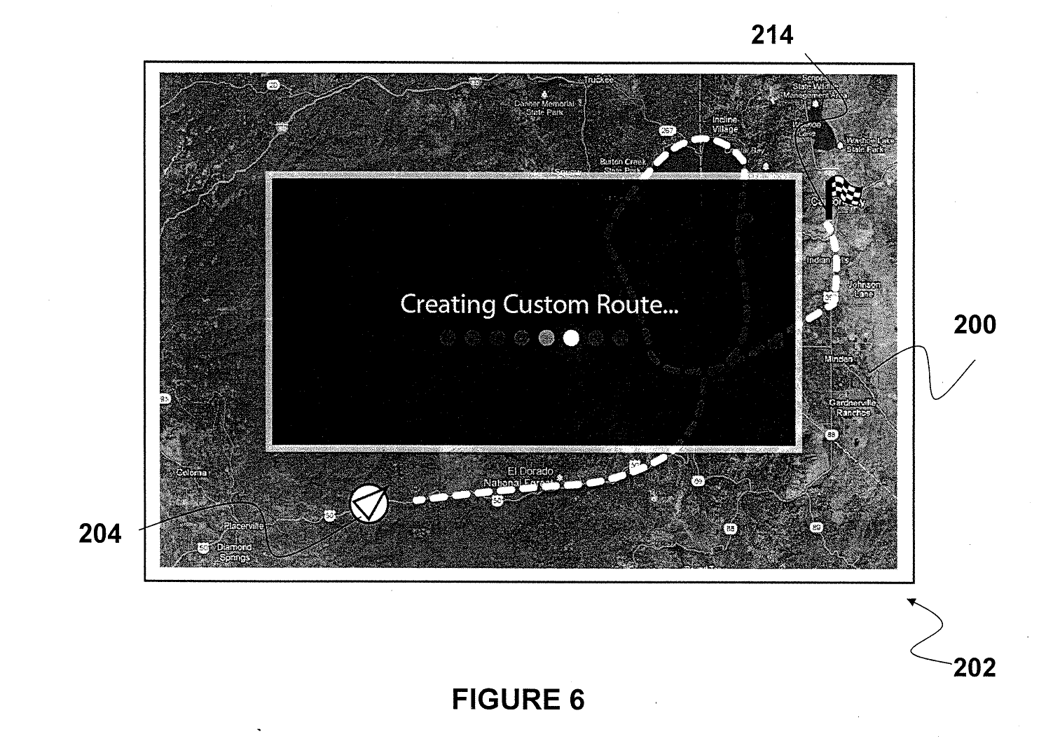

Subsequently, one or more algorithms utilized by the navigation system are used to compare the visually-defined route to an actual network of roads, highways, etc. available for implementing the visually-defined route, as illustrated in FIG. 6. This operation enables a user's specified preferences to be analyzed by the navigation system and implemented in a manner that is as close as possible to the specified preferences. It should be understood that this operation may take other criteria into account that may have been input or previously set by the user, e.g., an interest in avoiding traffic, improving fuel economy, avoiding toll roads, etc.

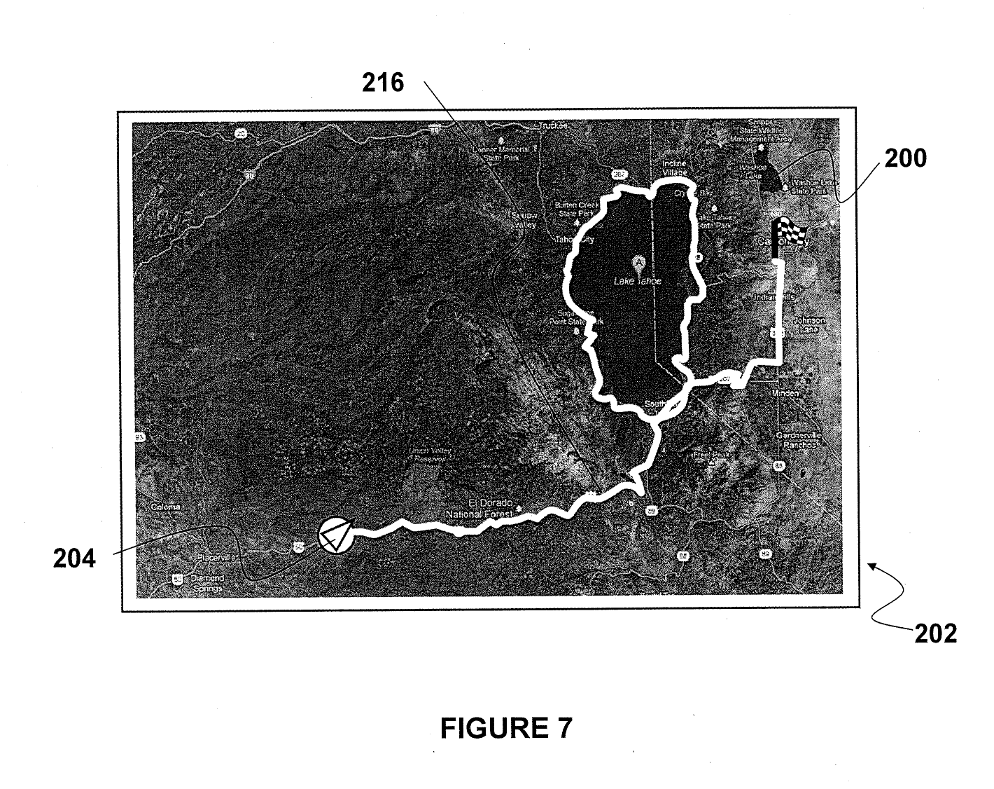

Based on this analysis, a custom route 216 defined by the user is formulated as shown in FIG. 7. In this way the custom route may be optimized for user-preference rather than speed, economy, etc. However, it should be understood that the comparison and formulation performed to provide the custom route may optionally take other criteria into account in addition to user preference; such additional criteria may have been input or previously set by the user, e.g., an interest in avoiding traffic, improving fuel economy, avoiding toll roads, etc.

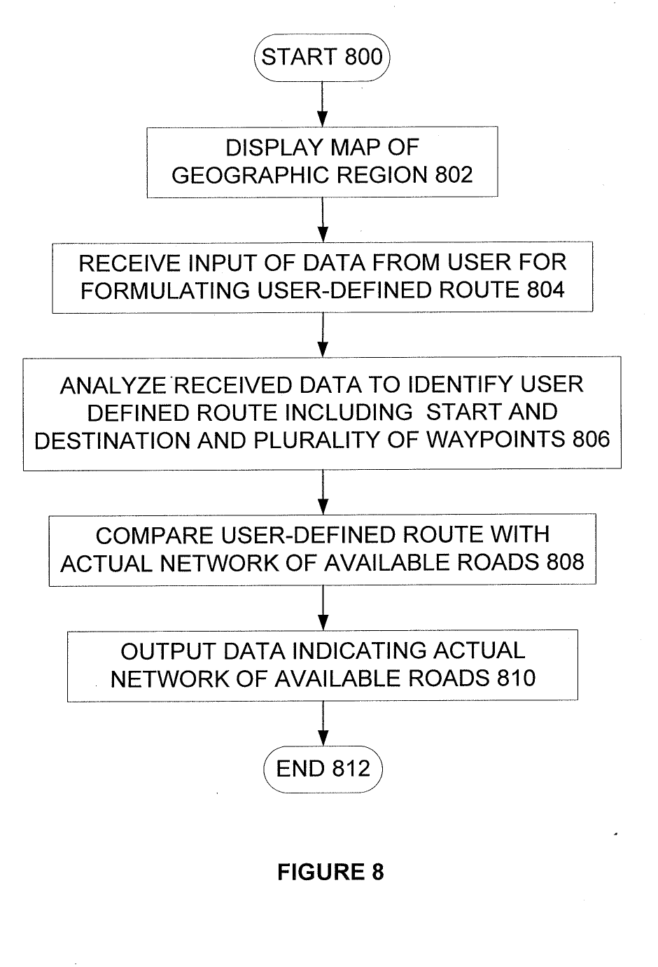

FIG. 8 illustrates one example of a methodology for enabling planning of a completely open-ended scenic route corresponding to FIGS. 2-7. As shown in FIG. 8, the operations begin at 800 and continue to 802, at which a map of a geographic region is displayed on a touch screen of the navigation system. Control then proceeds to 804, at which input of data is received from a user, wherein the data is to be used for formulating a user-defined route. Control then proceeds to 806, at which the received data are analyzed to identify and formulate a user defined navigation route including start, destination and a plurality of waypoints. Control then proceeds to 808, at which the user-defined route data is compared with data indicating actual networks of available roads to implement the route. Based on that comparison, a navigation route implemented using actual, available roads is formulated and output to a user via the touch screen on the display of the navigation system at 810. Control then proceeds to 812, at which operations for this particular functionality ends.

It should be appreciated that there may be multiple available routes to travel from one location to another and a user may want to select from these routes and/or alter one of these routes to suit their particular purposes. Thus, in accordance with disclosed embodiments, when there are multiple routes available to a destination, the navigation system 100 may use a routing algorithm to calculate and return a plurality of options that may be optimized for time and/or distance. However, the navigation system 100, its components and associated navigation route planning methodologies may then enable optimization of one or more of the navigation routes according to a user's personal preference for inclusion of at least one specific route segment.

Thus, in accordance with presently disclosed embodiments, for partially traced/drawn routes or route segments, the route formulation software algorithms may treat the beginning and end of drawn/traced segments as waypoints, thereby determining a route from the car's current location to the first waypoint, matching the drawn/traced segment to road data, and then determining a route from the second waypoint to the final destination. In this way, multiple segments or subpaths can also be drawn by the user and be incorporated into the navigation route calculation.

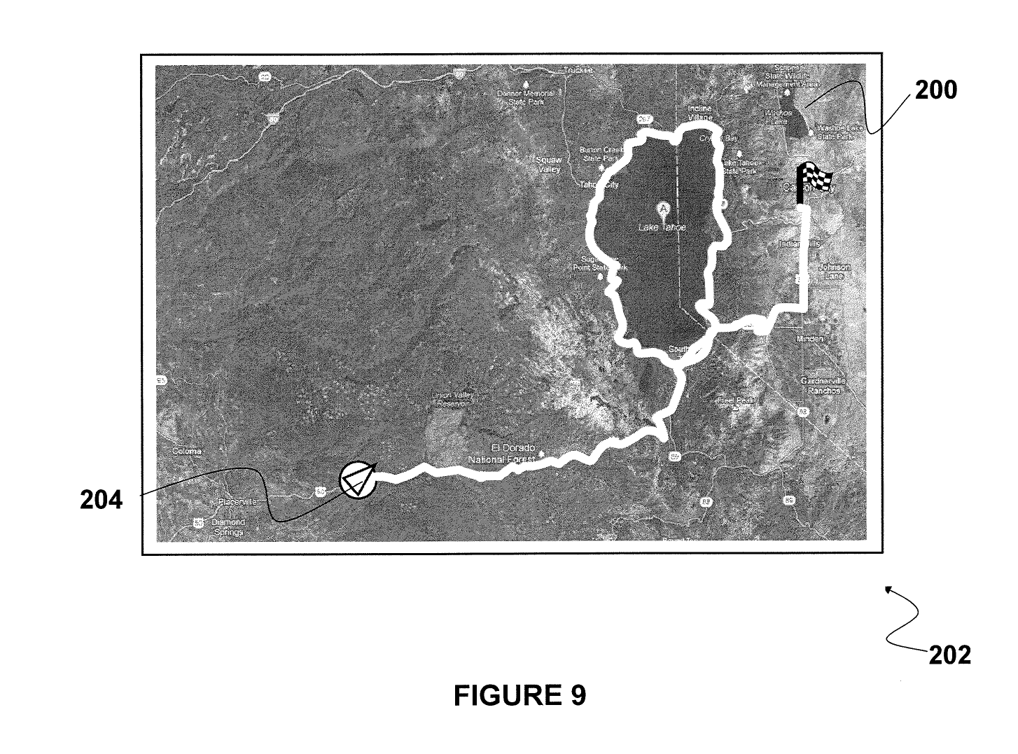

Thus, FIGS. 9-13 illustrate various examples of screen shots that may be displayed on a user interactive touch screen included in a user interface of a navigation system as part of planning and making an adjustment to a previously traced navigation route provided in accordance with the presently disclosed embodiments.

As shown in FIG. 9, a geographic region map 200 may be displayed on a touch screen display 202 with an icon indicating a user's present location 204 in combination with a previously formulated navigation route 216. Note, this previously formulated navigation route 216 may have been formulated based on the methodology illustrated in FIG. 8. Alternatively, the displayed navigation route 216 may have been formulated as one of a plurality of different options and/or formulated based on one or more criteria including time, distance, fuel economy, traffic, etc.

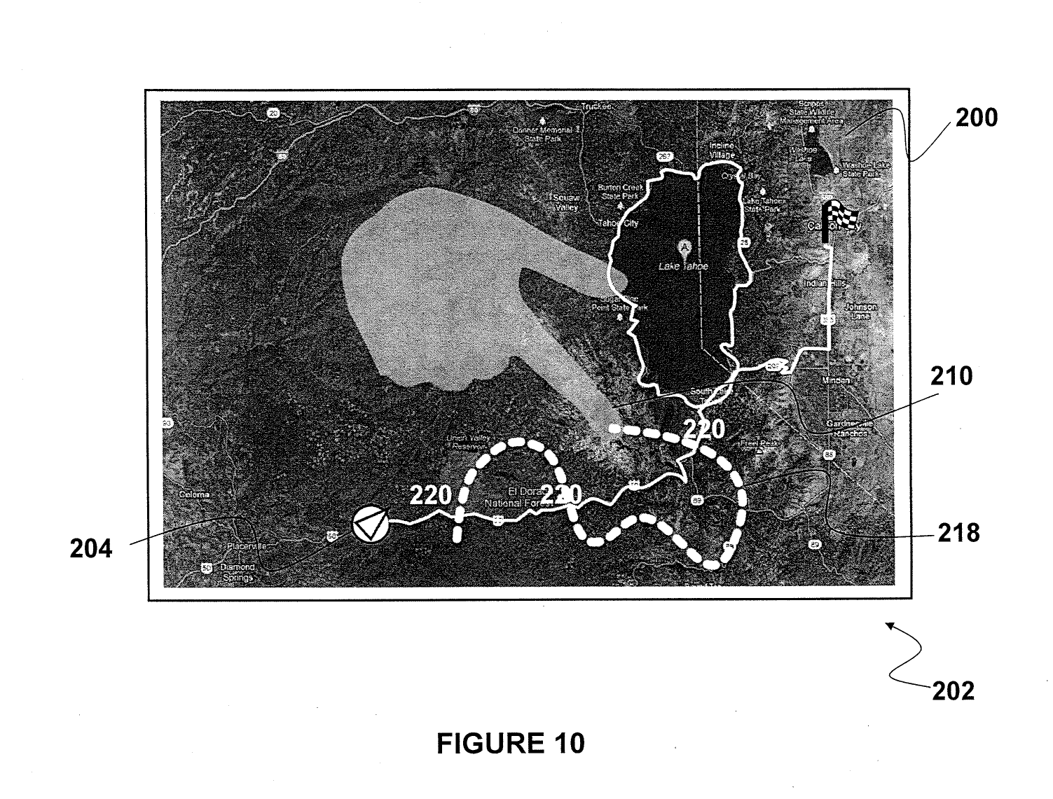

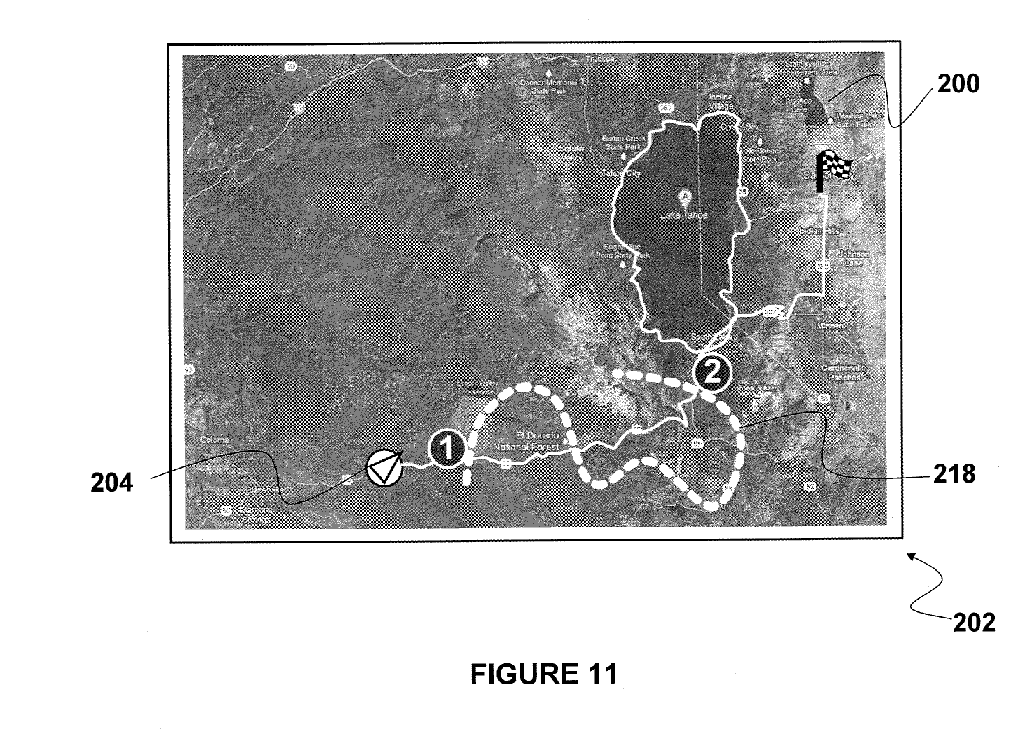

As shown in FIG. 10, the system and methodologies are configured to enable a user to draw/trace a route segment 218 on the geographic region map 200 displayed on the touch screen display 204 with their finger 210 or the like. Note, the newly drawn/traced path or route segment may cut across the previously formulated route in a number, e.g., three, locations 220. Location “1” and location “2,” illustrated in FIG. 11 may be treated as the beginning and end of the new route segment 218 for inclusion into the previously formulated navigation route 216.

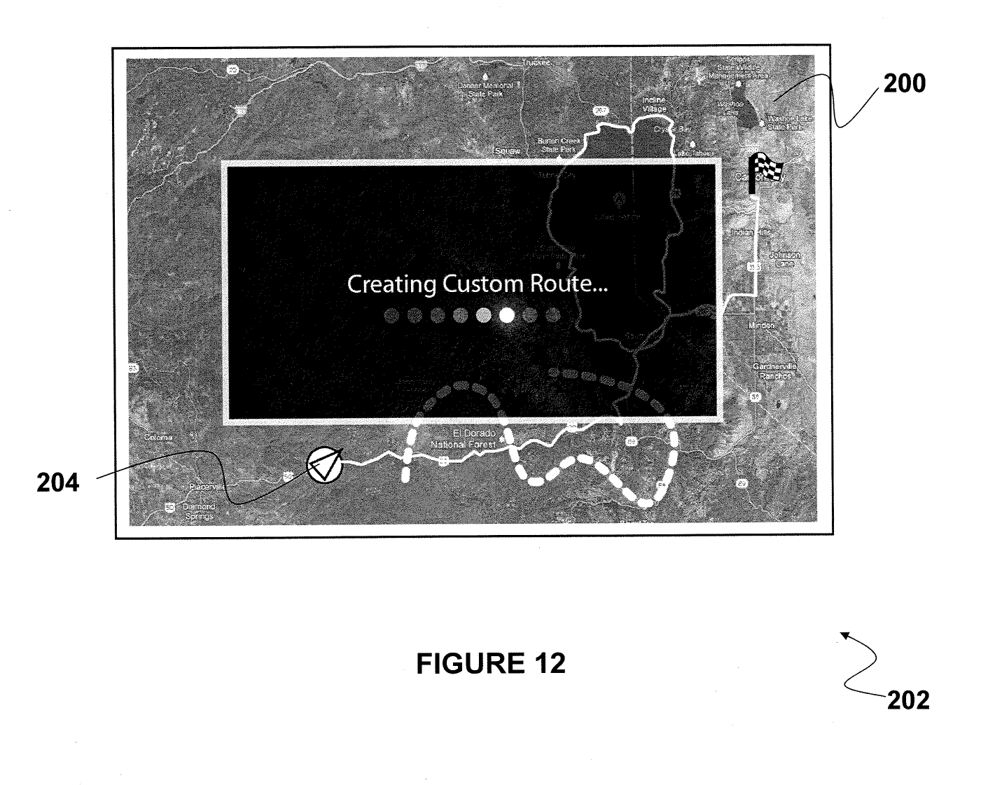

Subsequently, the navigation software algorithm(s) (also referred to as a Nav engine”) analyzes the new segment data and compares the new segment data with actual road data to formulate or calculate an updated navigation route that will include the newly added route segment, as illustrated in FIG. 12.

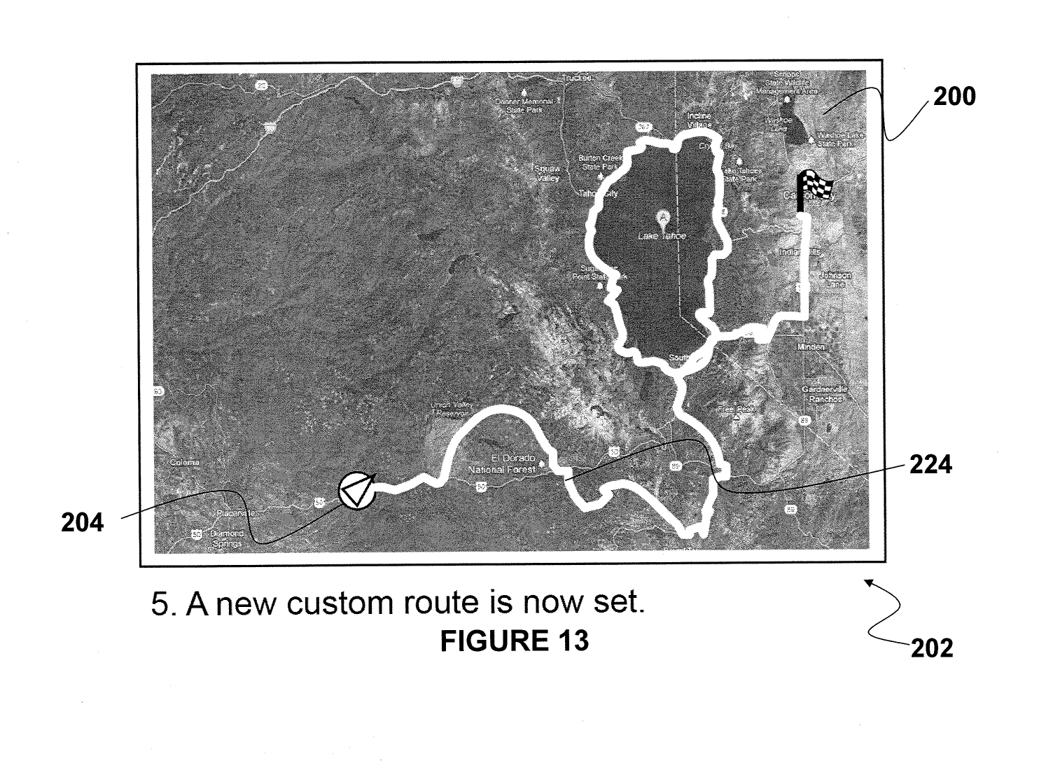

Based on this comparison, a newly formulated navigation route 222 that includes roads 224 for implementing the newly added route segment is formulated and displayed via the touch screen of the navigation display, as shown in FIG. 13. Again, it should be understood that the comparison and formulation performed to provide the custom route with the newly added route segment may optionally take other criteria into account in addition to user preference; such additional criteria may have been input or previously set by the user, e.g., an interest in avoiding traffic, improving fuel economy, avoiding toll roads, etc.

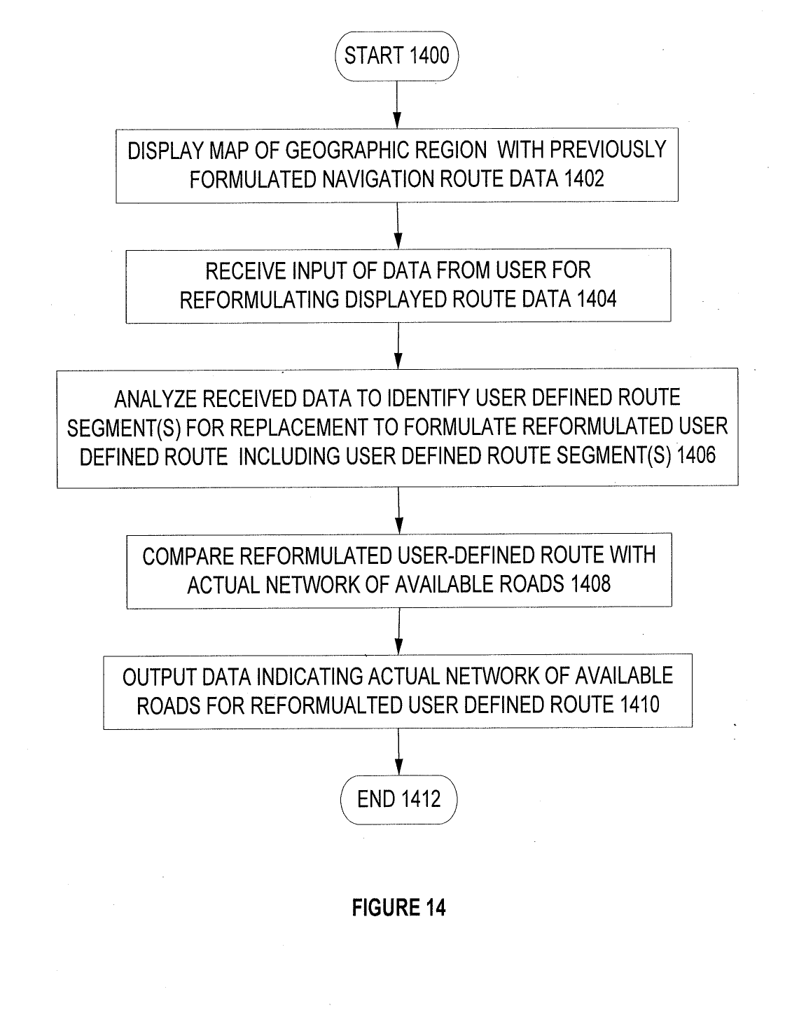

FIG. 14 illustrates one example of a methodology for enabling planning and making an adjustment to a previously traced navigation route corresponding to FIGS. 9-13.

As shown in FIG. 14, the operations begin at 1400 and continue to 1402, at which a map of a geographic region is displayed on a touch screen of the navigation system and which includes previously formulated navigation route data 1402, e.g., a navigation route. Control then proceeds to 1404, at which input of data is received from a user, wherein the data is to be used for re-formulating a user-defined route to include a newly drawn route segment. Control then proceeds to 1406, at which the received data are analyzed to identify the user defined route (segment(s) for placement or replacement) into the previously formulated route so as to formulate a reformulated user defined route that includes the user defined route segment(s). It should be understood that data for one or more than one newly drawn route segment may be analyzed in the operation. Control then proceeds to 1408, at which the reformulated user-defined route is compared with an actual network of available roads. Based on this comparison, the reformulated user defined navigation route is formulated and output via the touch screen on the display of the navigation system at 1410. Control then proceeds to 1412, at which operations for this particular functionality ends.

In accordance with disclosed embodiments, the system 100 may optimize formulated or reformulated navigation routes according to a user's personal preference for inclusion of at least one specific route segment as well as at least one of predicted time to travel the navigation route and distance along the navigation route and/or fuel economy. Accordingly, as disclosed above, the disclosed embodiments may provide one or more optimized navigation routes to a user to select from and each of these routes may provide a different weighting of the user's personal preference in relation to time of travel, distance along the navigation route and/or fuel economy.

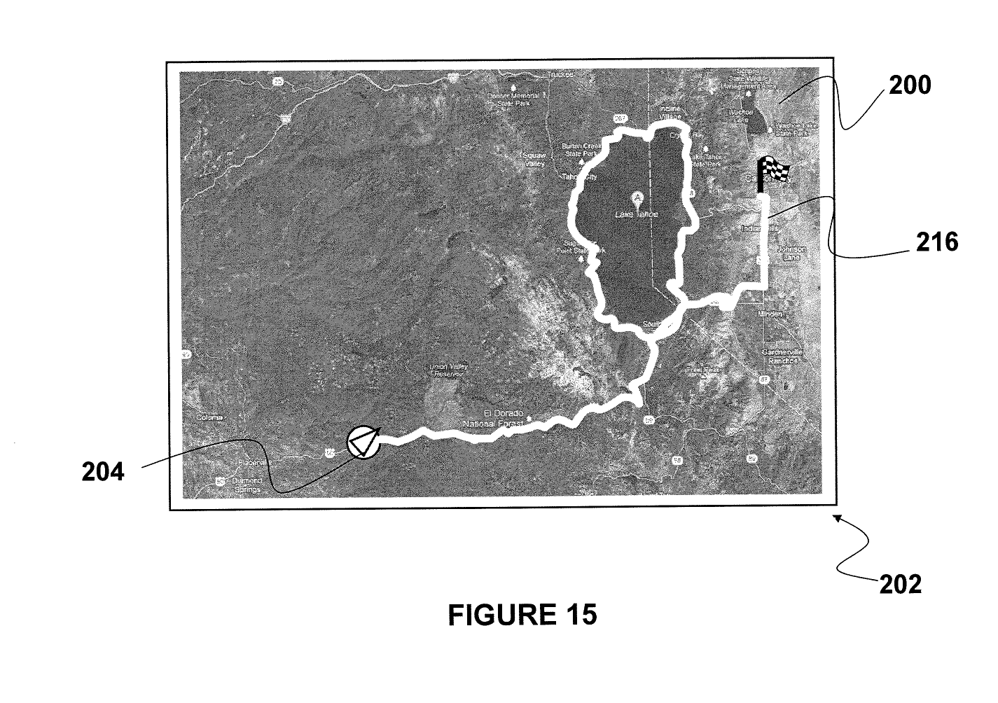

In accordance with disclosed embodiments, the navigation system, components and methodologies are configured to enable receipt and analysis of user preference data that may be used to cut out a previously formulated route, thereby resulting in an incomplete route that the user may then replace with additional user specified route segment data, For example, FIGS. 15-20 illustrate various examples of screen shots that may be displayed on a user interactive touch screen included in a user interface of a navigation system as part of enabling a user to adjust a previously traced route by cutting a segment out of a previously drawn navigation route to trigger re-drawing of the navigation route to include newly formulated navigation route data.

Thus, as shown in FIG. 15, a geographic region map 200 may be displayed on a touch screen display 202 with an icon indicating a user's present location 204 in combination with a previously formulated navigation route 216. Note, again, this previously formulated navigation route 216 may have been formulated based on the methodology illustrated in FIG. 8. Alternatively, the displayed navigation route 216 may have been formulated as one of a plurality of different options and/or formulated based on one or more criteria including time, distance, fuel economy, traffic, etc.

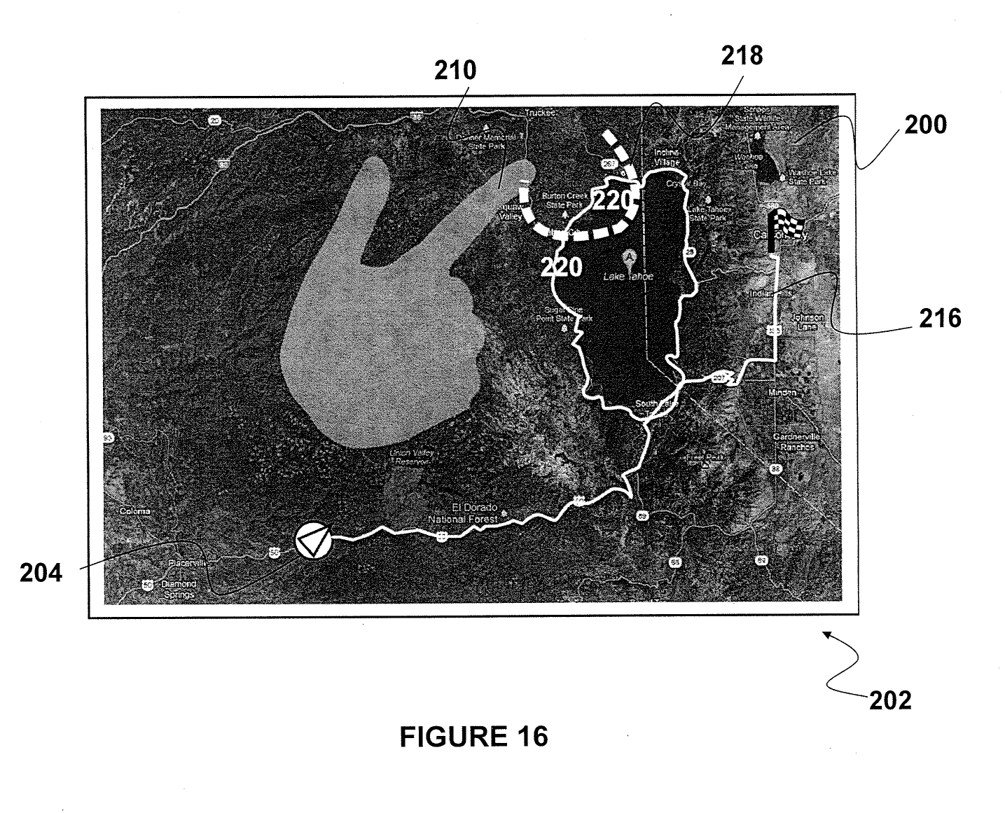

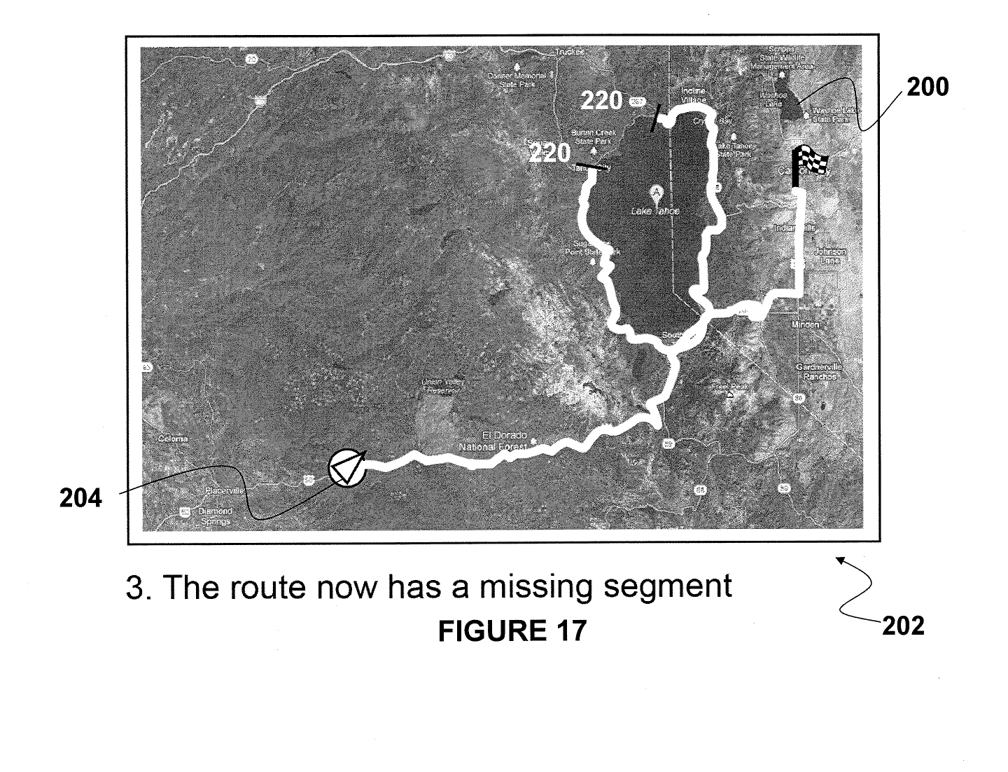

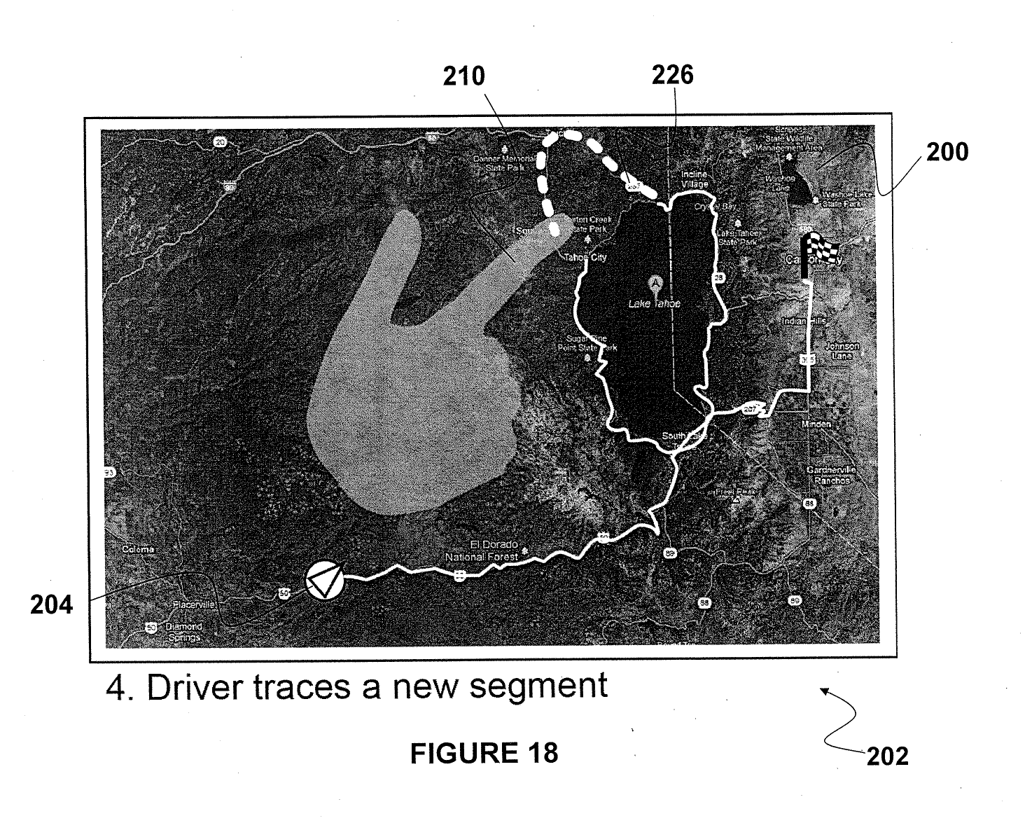

As shown in FIG. 16, the system and methodologies are configured to enable a user to draw/trace a newly added route segment 218 on the geographic region map 200 displayed on the touch screen display 204 with their finger 210 or the like. Note, the newly drawn/traced path or route segment may cut across the previously formulated route in a number, e.g., two, locations 220 in a manner that signifies that the route segment bordered by those locations is to be removed, e.g., indicating via direction and location of the draw/trace that the particular route segment is being cut out or torn out of the displayed navigation route, as illustrated in FIG. 17. As a result, the system and methodologies provides the opportunity for the user to draw/trace in a replacement route segment 226 for the omitted route segment as shown in FIG. 18.

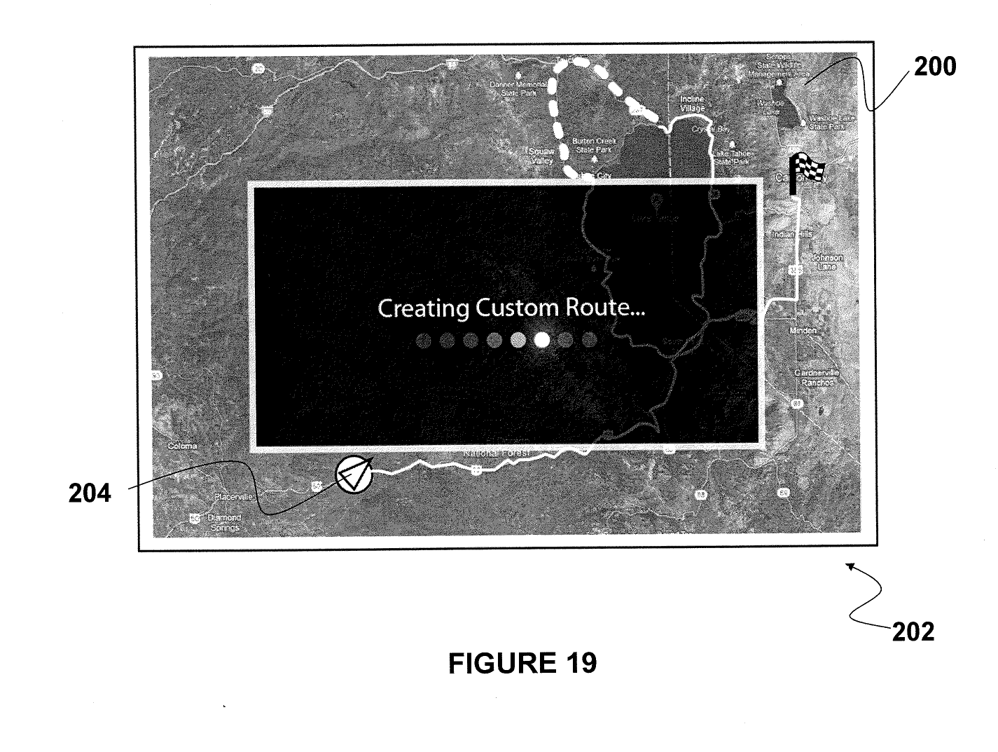

Subsequently, the navigation software algorithm(s) analyzes the new segment data and compares the new segment data with actual road data to formulate or calculate an updated navigation route that will include the replacement route segment 226, as illustrated in FIG. 19.

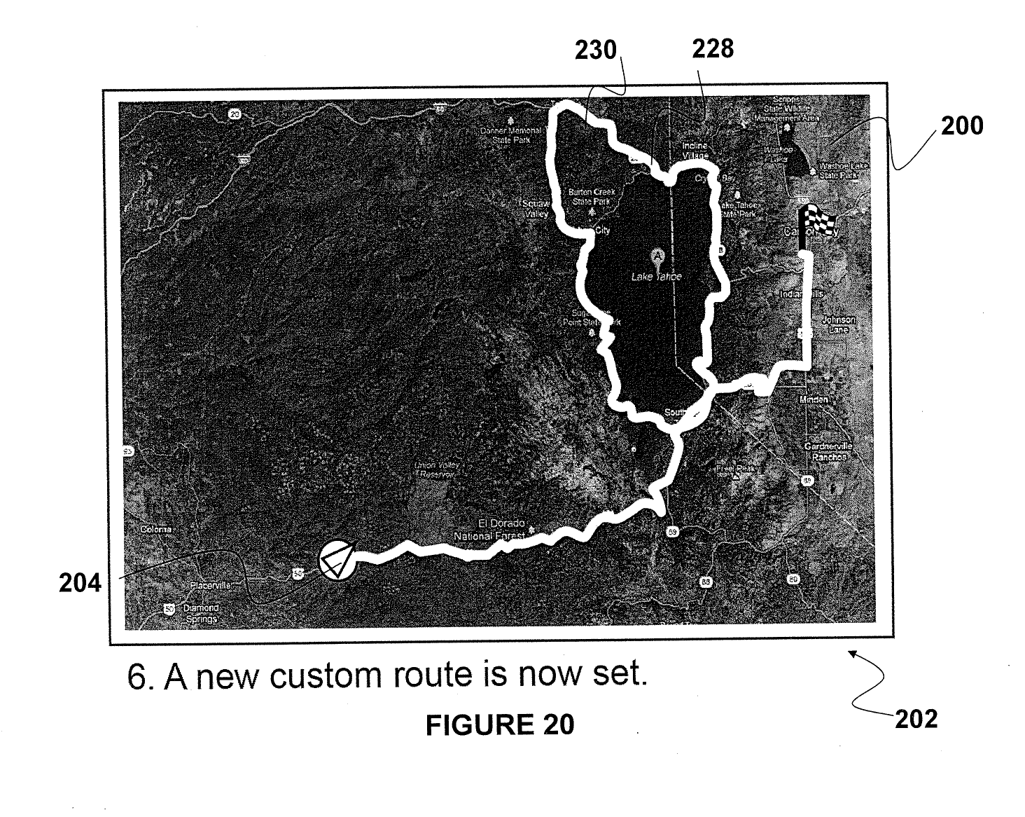

Based on this comparison, a newly formulated navigation route 228 that includes roads 230 for implementing the newly added route segment is formulated and displayed via the touch screen of the navigation display, as shown in FIG. 20. Again, it should be understood that the comparison and formulation performed to provide the custom route with the newly added route segment may optionally take other criteria into account in addition to user preference; such additional criteria may have been input or previously set by the user, e.g., an interest in avoiding traffic, improving fuel economy, avoiding toll roads, etc. Moreover, it should be understood that the receipt of replacement route segment data may be omitted if it is not received from the user; in such an option, the system and methodologies could be configured to automatically (or in response to an instruction by the user).

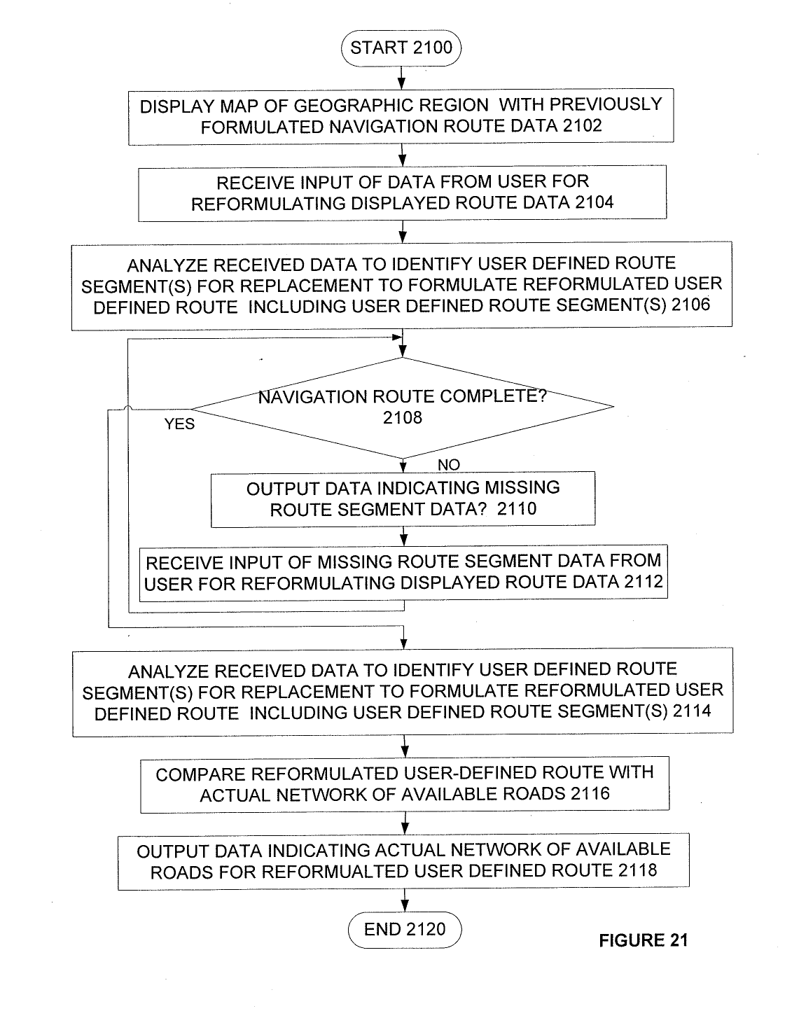

FIG. 21 illustrates one example of a methodology for enabling a user to adjust a previously traced route by cutting a segment out of a previously drawn navigation route to trigger re-drawing of the navigation route corresponding to FIGS. 15-20. As shown in FIG. 21, the operations begin at 2100 and continue to 2102, at which a map of a geographic region is displayed on a touch screen of the navigation system and which includes previously formulated navigation route data 2102, e.g., a navigation route. Control then proceeds to 2104, at which input of data is received from a user, wherein the data is to be used for re-formulating a user-defined route to delete a route segment and, optionally, replace it with a user-input route segment. Control then proceeds to 2106, at which the received data are analyzed to identify the user defined route (segment(s) for deletion or replacement into the previously formulated route) so as to formulate a reformulated user defined route that includes the user defined route segment(s). It should be understood that data for one or more than one newly drawn route segment may be analyzed in the operation. Control then proceeds to 2108, at which the reformulated user-defined route is analyzed to determine whether the navigation route is complete. If it is, control proceeds to 2114, explained herein. However, if the navigation route is not complete, control proceeds to 2110, at which data is output to the navigation display indicating what route segment(s) are missing. It should be understood that, at this point, the navigation software algorithm(s) may output instructions, queries or other data to elicit input from the user as to whether replacement route segment will be input by the user or it should be formulated by the algorithms based on conventionally known route optimization methodologies (an option that is not illustrated in FIG. 21 but is within the scope of the disclosed embodiments). Control then proceeds to 2112, at which user inputted missing route segment data is received (or, optionally, formulated by the navigation software algorithm(s)). Control then proceeds to 2114, at which the missing route segment data is then analyzed to identify user defined route segment(s) for replacement to formulate a re-formulated user-defined route including the newly added user-defined route segment(s). Control then proceeds to 2116 at which the reformulated user-defined route is compared with available roads. Based on this comparison, the reformulated user defined navigation route is formulated and output via the touch screen on the display of the navigation system at 2118. Control then proceeds to 2120, at which operations for this particular functionality ends.

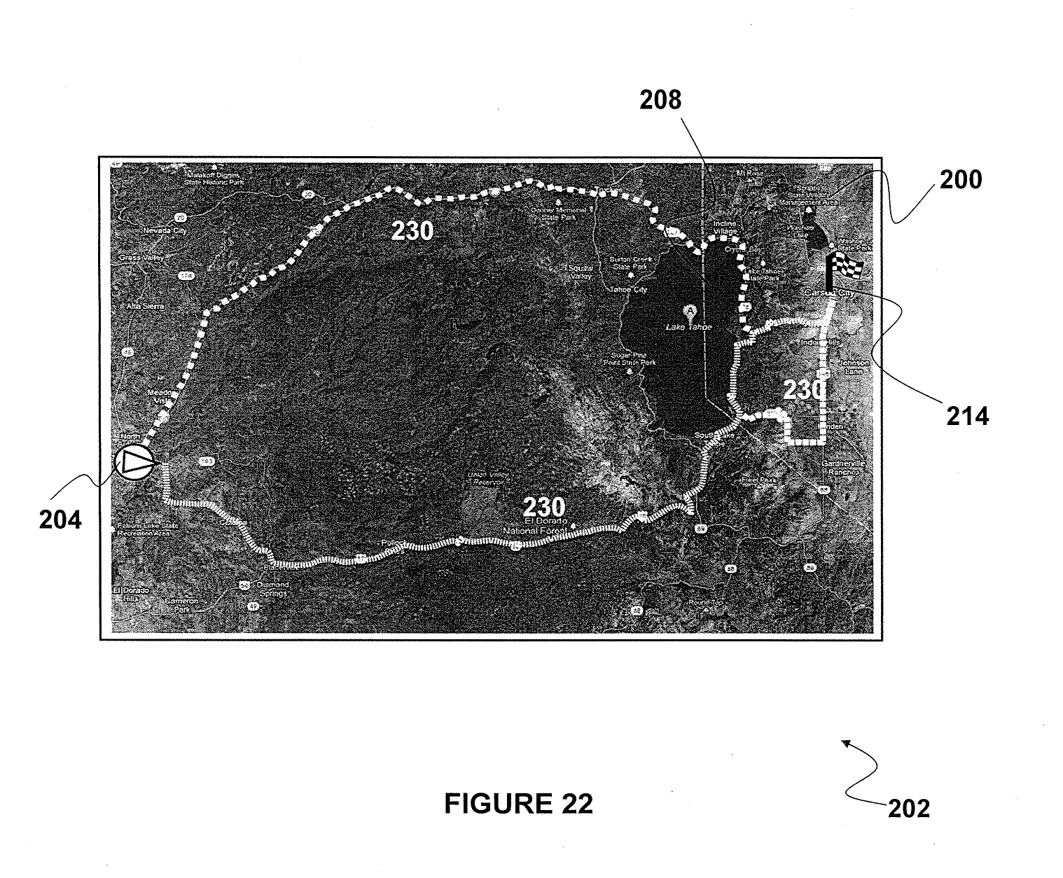

FIGS. 22-27 illustrate various examples of screen shots that may be displayed on a user interactive touch screen included in a user interface of a navigation system as part of a methodology enabling a user to input/trace a route segment for inclusion in a navigation route being formulated in accordance with the presently disclosed embodiments. As shown in FIG. 22, a user (e.g., driver, passenger, etc.) may be presented with a plurality of route options 230 for travelling to a present location (designated by icon 204) to a destination 214 selected by the user on a displayed geographic region map 200. For example, the displayed navigation route options 230 may have been formulated based on one or more criteria including time, distance, fuel economy, traffic, etc.

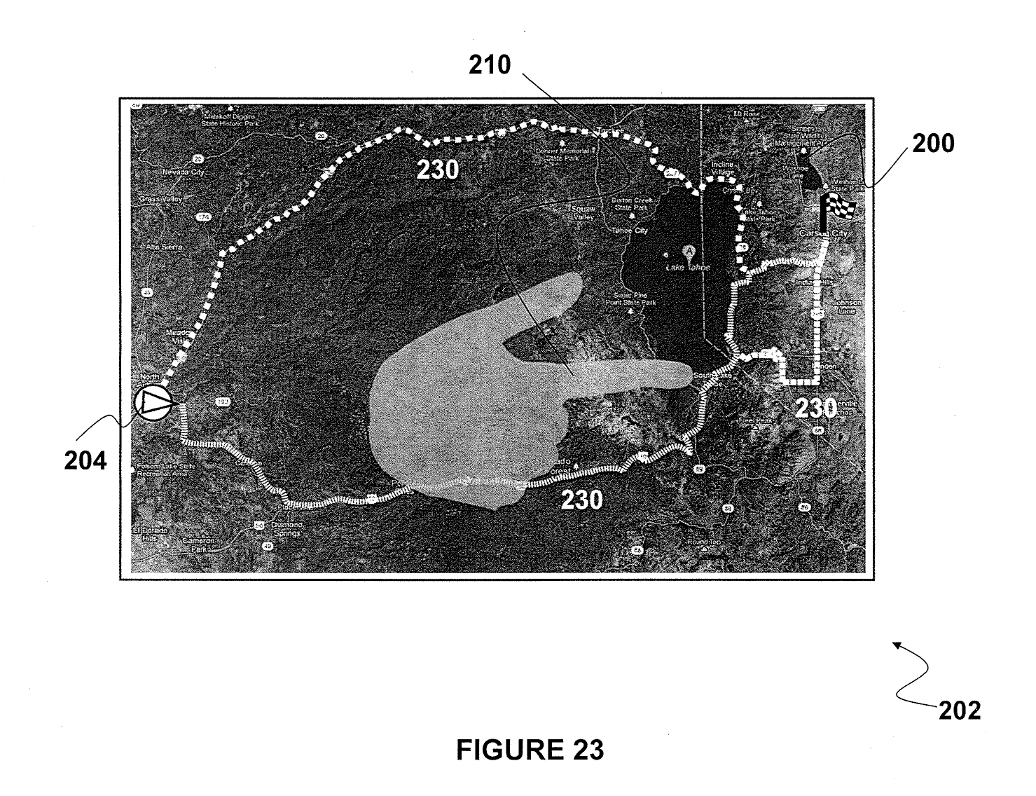

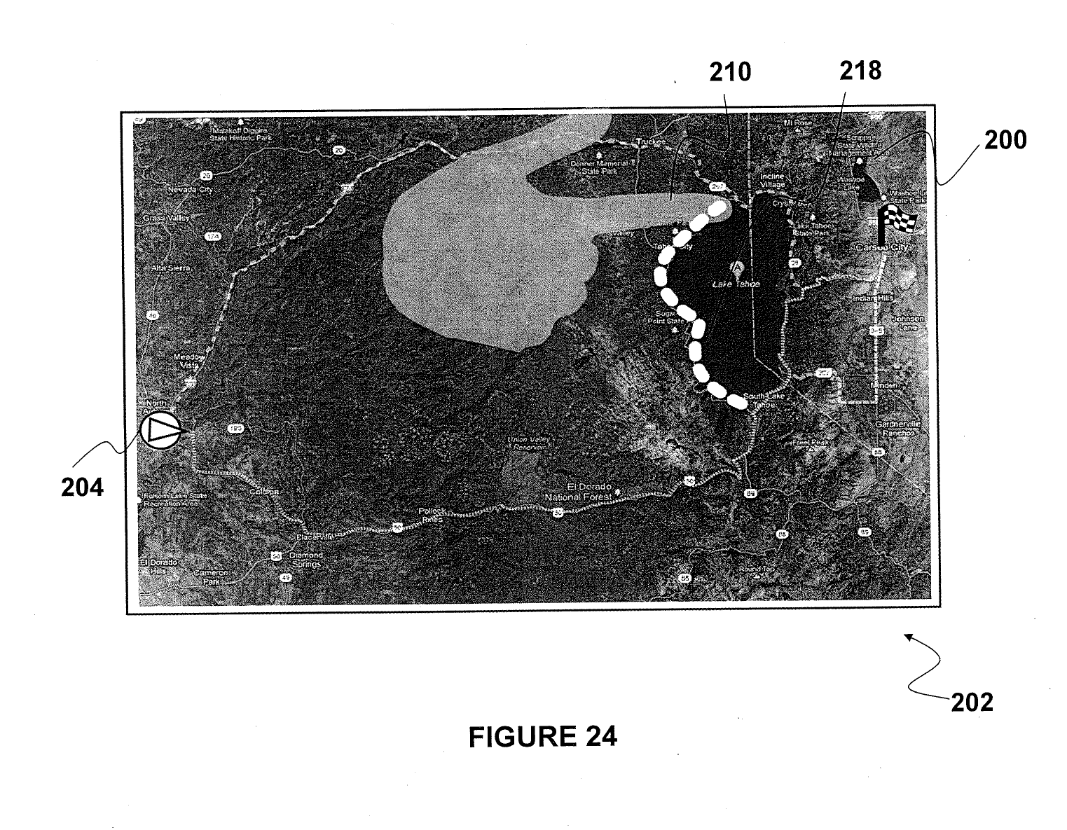

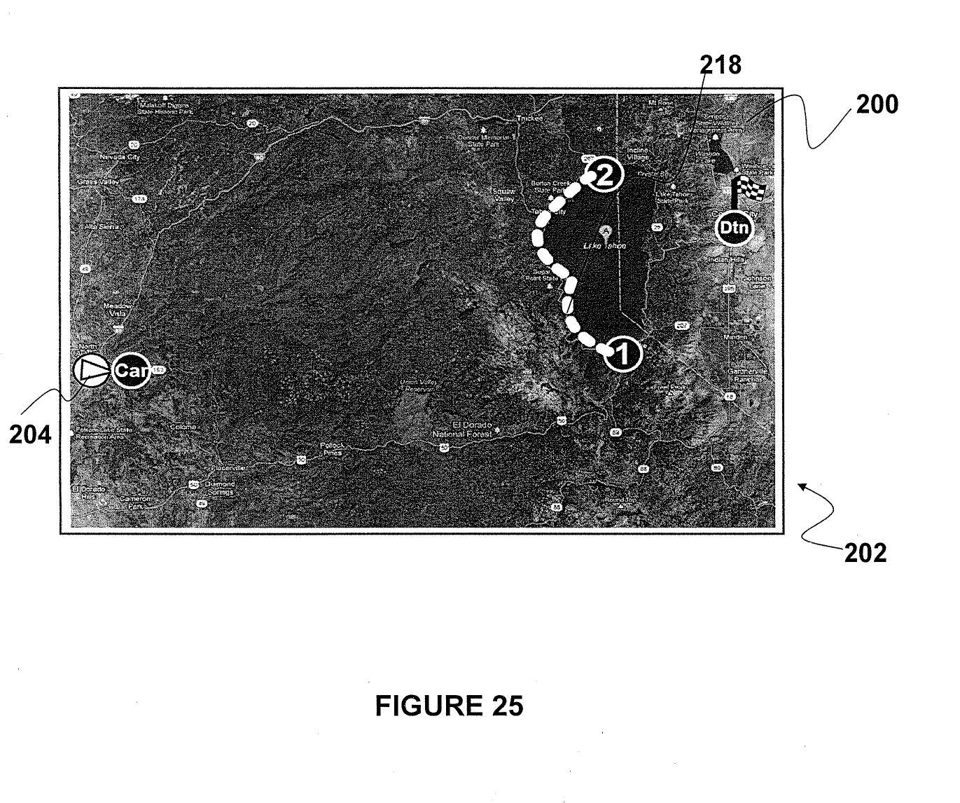

However, the user may not wish to use one of the formulated route options 230 because, for example, he wishes to sight see by driving up the west coast of Lake Tahoe 208 on the way to Carson City, which is his final destination 214, as illustrated in FIG. 23. Alternatively, the user may wish to stop during his route to see a friend who lives on the lake, run an errand to shop for something that is available for sale at a store he knows is located on the lake, etc. Accordingly, as shown in FIG. 24, the user uses his finger 210 to input a newly added route segment 218 on the geographic region map 200 shown on the navigation system's display 202. As shown in FIG. 25, the newly drawn/traced path or route segment 218 may touch one or more of the previously displayed routes but need not have any locations in common with the plurality of displayed routes. Subsequently, as shown in FIG. 25, the Location “1” and location “2” may be treated as the beginning and end of the new route segment 218 for inclusion into one of the previously formulated navigation route options 230 between the present location of the user 204 and the selected destination 214; alternatively, the newly input route segment 218 may be included in a newly formulated navigation route that may have overlapping route segments with one or more of the previously displayed route options 230 or no overlapping segments.

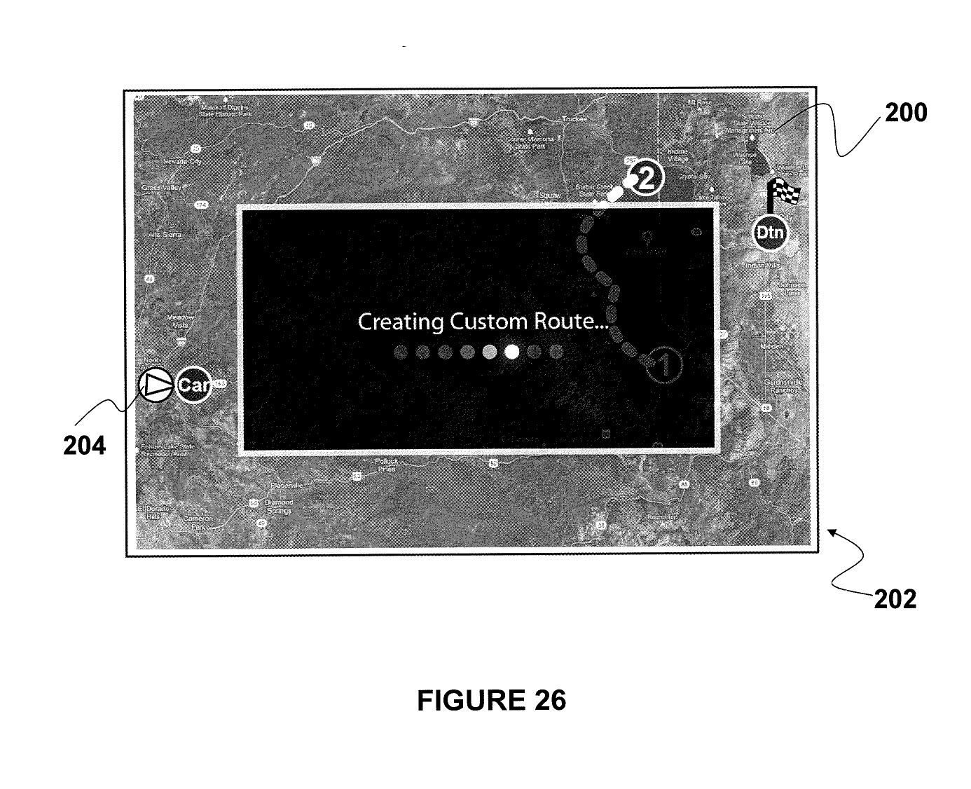

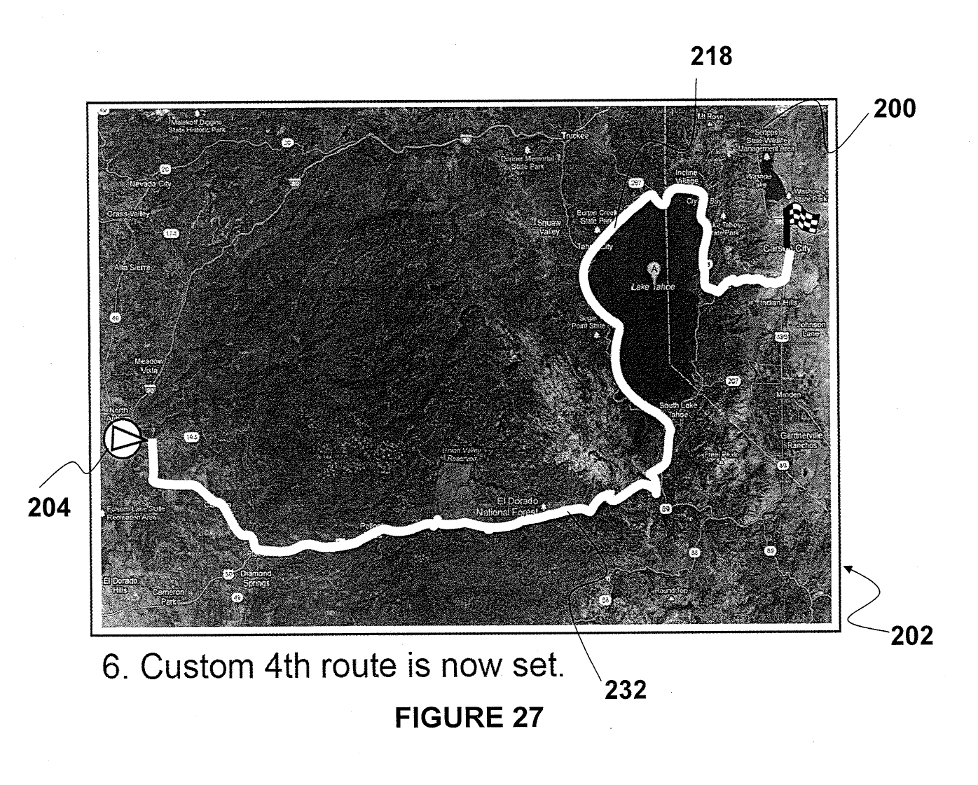

Thus, as shown in FIGS. 25-26, the start and end points of the newly added route segment are treated as waypoints at locations “1” and “2,” respectively, and the navigation software algorithm formulates a route from the current location of the car 204 to location “1,” matches the route segment 1-2 to available route data and calculates a route from location “2) to the selected destination 214. Thus, the navigation software algorithm(s) formulate or calculate an updated navigation route that will include the newly added route segment, as illustrated in FIG. 27.

Based on this comparison, a newly formulated navigation route 232 that includes roads 224 for implementing the newly added route segment 218 is formulated and displayed via the touch screen of the navigation display, as shown in FIG. 27. Again, it should be understood that the comparison and formulation performed to provide the custom route with the newly added route segment may optionally take other criteria into account in addition to user preference; such additional criteria may have been input or previously set by the user, e.g., an interest in avoiding traffic, improving fuel economy, avoiding toll roads, etc.

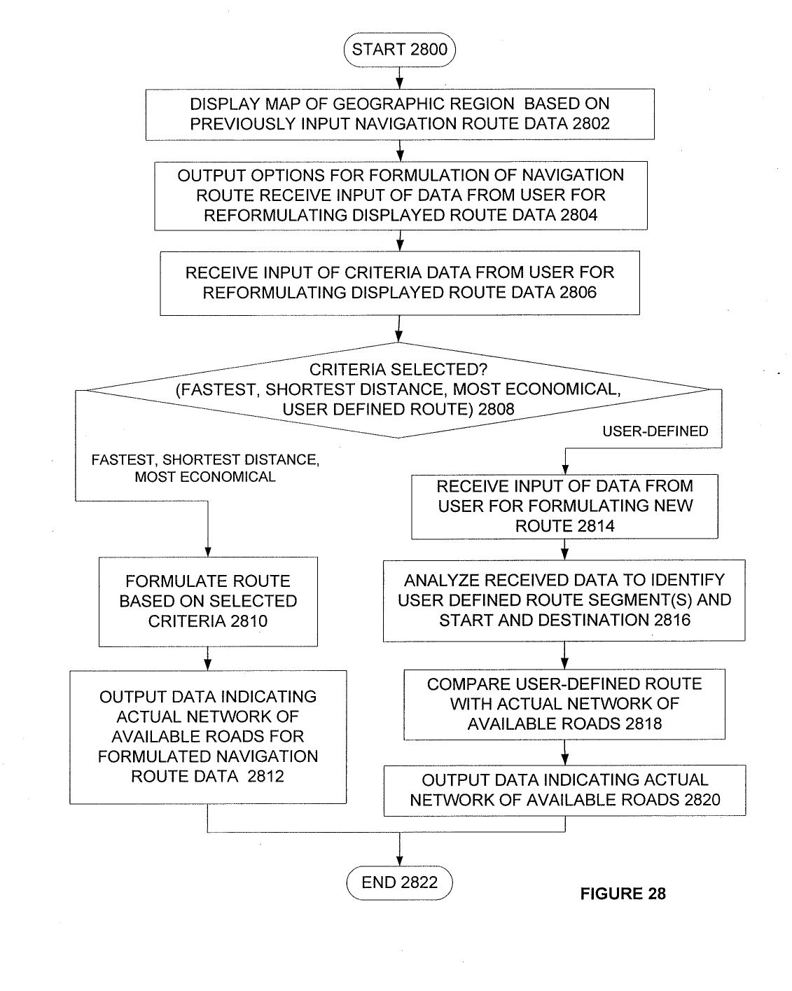

FIG. 28 illustrates one example of a methodology for enabling a user to input/trace a route segment for inclusion in a navigation route being formulated corresponding to FIGS. 22-27.

As shown in FIG. 28, the operations begin at 2800 and continue to 2802, at which a map of a geographic region is displayed on a touch screen of the navigation system. Various route options for selection (to aid in formulation of a navigation route) may be output to the user at 2804. Subsequently, the system receives input of criteria data from the user for reformulating displayed route data at 2806. The criteria is analyzed to determine which criteria has been selected to enable selection of a navigation mode, e.g., fastest, shortest distance, most economical and/or user defined, 2808. If fastest, shortest distance, or most economical has been selected by the user, one or more navigation routes are formulated based on the selected criteria using conventionally known techniques at 2810. Subsequently, output of data indicating an actual network of available roads is provided for formulating navigation route data 2812. This may include display of one or more routes based on the selected criteria (or alternatively, could include routes directed to various different criteria (as illustrated in FIG. 22).

If user-defined mode is selected, the system receives newly input data via the user drawing/tracing on the touch screen of the display at 2814. Control then proceeds to 2816, at which received data is analyzed to identify user defined route segment(s) and start and designation locations. Control then proceeds to 2818, at which the user-defined route segment(s) is compared with an actual network of available roads. Based on this comparison, the user defined navigation route is formulated and output via the touch screen on the display of the navigation system at 2820; it should be understood that, consistent with the disclosure above, an incomplete route from current location, e.g., start, to a specified destination may utilize navigation route formulating algorithms to complete a navigation route around the user-defined route segments (with segment endpoints treated as waypoints). Control then proceeds to 2822, at which operations for this particular functionality ends.

Disclosed embodiments provide a solution to the technical problem that conventional navigation systems do not enable a user to influence a formulated navigation route beyond a basic set of parameters and do not enable a user to input user-defined route segments into a navigation that has already been or is to be formulated.

Accordingly, disclosed embodiments offer a solution to this technical problem by simplifying the process for including a specific route segment on a calculated route from a starting location to a destination. Accordingly, the navigation system, its components and the associated navigation route planning methodologies enable planning based on at least a user's personal preference for the inclusion of at least one specific route segment in a planned navigation route.

Although the disclosed embodiments have been disclosed herein with reference to a touch screen included in a display wherein the user inputs commands and data by interacting with a displayed map of a geographic region, it should be understood that the touch screen display may also be configured to accept input of textual data entry via a displayed alpha-numeric keyboard and/or input of processing and navigation commands via interaction of a user with a displayed user keyboard, various displayed icons and/or interaction with buttons, dials, knobs located near the display and configured to be used in conjunction with the display.

Additionally, it should be understood that the navigation system may also receive input data and commands via speech of a user and, therefore, may includes software, e.g., speech recognition software, that is configured to analyze spoken word and translate spoken word into commands, instructions and input data. Further, such software may also be configured to identify geographic landmarks based on spoken names of such landmarks along with instructions for navigating near such landmarks, e.g., “drive along west short of Lake Tahoe.” Accordingly, it should be appreciated that the navigation software may further be configured to identify and select the waypoints associated with such an instruction and incorporate those waypoints into a previously formulated or presently formulated navigation route.

1. A navigation system comprising:
a user interface including a touch screen display that outputs data to a user and receives data input from the user; and
a processor configured to receive data input via the user interface and formulate a navigation route from a route start to a route destination, wherein the processor is further configured to
receive and analyze data input via the user interface, wherein the data input comprises a traced path corresponding to one or more route segments indicating a user-defined navigation route segment, and
incorporate the user-defined navigation route segment within a navigation route as part of formulating the navigation route from the route start to the route destination.

2. The navigation system of claim 1, wherein the traced path is comprised of inputs on the touch screen display.

3. The navigation system of claim 2, wherein the traced path is analyzed by the processor to determine the at least one user-defined navigation route segment.

4. The navigation system of claim 1, wherein the processor is further configured to display at least one navigation route option on a geographic region map on the user interface.

5. The navigation system of claim 1, wherein endpoints of the at least one user-defined navigation route segment are treated as first and second waypoints and included into a formulated navigation route by identifying a route segment from the route start to the first waypoint and a route segment from the second waypoint to the route destination to provide a complete formulated navigation route from the route start to the route destination and including the at least one user-defined navigation route segment.

6. The navigation system of claim 5, wherein the identification of the route segment from the route start to the first waypoint and the route segment from the second waypoint to the route destination are each performed based on at least one of the following criteria: fastest route, shortest distance, least traffic, and most economical.

7. The navigation system of claim 1, wherein the processor is further configured to reformulate a previously formulated navigation route based on newly input, user-defined route segment data received via the user interface.

8. The navigation system of claim 1, further comprising at least one transceiver coupled to the processor and accessing navigation data for use by the processor in formulating navigation routes.

9. The navigation system of claim 8, wherein the navigation data is Global Positioning System data.

10. The navigation system of claim 6, wherein the at least one transceiver also accesses traffic data indicating at least one of traffic accident event data for a geographic region and a level of traffic congestion in the geographic region.

11. The navigation system of claim 1, wherein the processor is configured to establish a link with a mobile device and utilize communication services available to the mobile device to obtain navigation data for use by the processor in formulating navigation routes.

12. The system of claim 1, further comprising memory including at least one software algorithm and reference data for formulating navigation routes in one or more geographic regions.

13. A method for navigation route planning, the method comprising:
displaying a map of a geographic region on a touch screen;
receiving input user-defined route data from a user for formulating at least one user-defined navigation route segment via the touch screen, wherein the user-defined route data comprises a traced path corresponding to one or more route segments on the map; and
analyzing the received, user-defined route data using a processor coupled to the touch screen to identify and formulate a user defined navigation route including a route start, route destination and a plurality of waypoints corresponding to the at least one user-defined navigation route segment.

14. The method of claim 13, further comprising comparing the formulated user-defined route data with data indicating available roads to implement the formulated user-defined route and formulating and outputting a navigation route implemented using available roads to the user via the touch screen.

15. (canceled)

16. The method of claim 13, wherein the traced path is analyzed to formulate the at least one user-defined navigation route segment.

17. The method of claim 13, wherein endpoints of the at least one user-defined navigation route segment are treated as first and second waypoints and included into a formulated navigation route by identifying a route segment from the route start to the first waypoint and a route segment from the second waypoint to the route destination to provide a complete formulated navigation route from the route start to the route destination and including the at least one user-defined navigation route segment.

18. The method of claim 17, wherein the identification of the route segment from the route start to the first waypoint and the route segment from the second waypoint to the route destination are each performed based on at least one of the following criteria: fastest route, shortest distance, least traffic, and most economical.

19. The method of claim 1, further comprising reformulating a previously formulated navigation route based on newly input, user-defined route segment data received via the user touch screen.

20. The method of claim 1, further comprising accessing navigation data and utilizing that navigation data to formulate at least one navigation route, wherein the navigation data is accessed using at least one transceiver coupled to the processor.

21. The method of claim 20, wherein the navigation data is Global Positioning System data.

22. The method of claim 20, further comprising accessing traffic data indicating at least one of traffic accident event data for a geographic region and a level of traffic congestion in the geographic region using the at least one transceiver, wherein the traffic data is utilized to formulate the user define navigation route.

23. The method of claim 13, further comprising establishing a link between the processor and a mobile device and utilizing communication services available to the mobile device to obtain navigation data for use by the processor in formulating navigation routes.

24. A transportation system comprising:
a navigation system including a processor configured to receive data input via a user interface and formulate a navigation route from a route start to a route destination, wherein the processor is further configured to receive and analyze data input via the user interface and wherein the data input comprises a traced path corresponding to one or more route segments indicating at least one user-defined navigation route segment; and
a passenger vehicle including the user interface which further includes a touch screen display that outputs data to the user and receives data from the user,
wherein the processor is configured to incorporate the at least one user-defined navigation route segment within a user-defined navigation route as part of formulating the user-defined navigation route from the route start to the route destination, wherein a navigation route is formulated to include available roads by comparing the user-defined navigation route with data indicating available roads, and the formulated navigation route including available roads is output via the touch screen display.

25. The navigation system of claim 24, further comprising a communication link between the processor and a mobile device that enables the processor to utilize communication services available to the mobile device to obtain navigation and/or traffic data for use by the processor in formulating navigation routes.
